(19) United States
(12) Patent Application Publication
(10) Pub. No.: US 2008/0060479 A1
(43) Pub. Date: Mar. 13, 2008

(54) Combination beverage holder with bottle opener

(76) Inventor: Jason H. Nelson, Jacksonville, FL (US)

Correspondence Address: LITMAN LAW OFFICES, LTD., P.O. BOX 15035, CRYSTAL CITY STATION, ARLINGTON, VA, 22215, US

(21) Appl. No.: 11/896,562

(22) Filed: Sep. 4, 2007

Related U.S. Application Data
(60) Provisional application No. 60/842,655, filed on Sep. 7, 2006.

(51) Int. Cl. B67B 7/44; B67B 7/00

(52) U.S. Cl. 81/3.09; 220/737; 224/572

(57) ABSTRACT

The combination beverage holder with bottle opener is an insulated beverage holder for use with cold drinking containers, and has a substantially hollow body open at its top and a beverage support wall at its bottom. A bottle opener is attached to the bottom wall or to a rigid support attached to the bottom wall and proximate sidewalls of the beverage holder. A plurality of straps having extensions with hook and loop attachment fasteners are attached around the substantially hollow body for cinching the beverage holder snugly to the beverage container and for attaching the beverage holder to a post or other support.

### CROSS-REFERENCE TO RELATED APPLICATION

This application claims the benefit of U.S. Provisional Patent Application Ser. No. 60/842,655, filed Sep. 7, 2006.

### BACKGROUND OF THE INVENTION

1. Field of the Invention

The present invention relates to holders for bottles or cans containing a beverage, and particularly to a combination beverage holder and bottle opener for boats and other vehicles or structures having a post that the holder can be secured to.

2. Description of the Related Art

Over the years numerous beverage coasters and jackets have been developed and marketed for the purposes of keeping the beverage container cold or hot and for prohibiting the condensation, which often forms on the outside of a cold container, from being deposited on furniture, such as a wooden table.

To overcome the lack of portability in the aforementioned coasters and jackets, insulated beverage holders have been designed for insulating a beverage container while using a resilient yet collapsible material in order to provide a high degree of insulation for the purposes of keeping the beverage container cold, and easy stowage. Many of these beverage container holders have been marketed and distributed under such trade names as KOOZIES®, COZIES®, COOZIES®, and the like. Yet, one thing lacking has to date been a convenient means for popping a bottle top when it is desired to consume the beverage being held by the holder.

Thus a combination beverage holder with bottle opener solving the aforementioned problems is desired.

### SUMMARY OF THE INVENTION

The combination beverage holder with bottle opener is an insulated beverage holder for use with cold drinking containers, and comprises a substantially hollow body open at its top and a beverage support wall at its bottom. A bottle opener may be attached to the bottom wall of the cylindrical body. A plurality of fabric straps having extensions with hook and loop attachment strips are attached around the cylindrical body for cinching the beverage holder snugly to the beverage container and for attaching the beverage holder to a post, column, or other supporting member. The bottle opener is disposed on, and attached to, the bottom of the beverage holder, or to a rigid, annular support attached to the bottom wall proximate the sidewalls of the beverage holder, so that the attached bottle opener can provide a pivot point about which a bottle having its cap engaged in the bottle opener may be rotated to pop off the engaged cap from the bottle when the beverage holder is attached to a support using the attachment strips.

These and other features of the present invention will become readily apparent upon further review of the following specification and drawings.

### BRIEF DESCRIPTION OF THE DRAWINGS

FIG. 1 is an environmental, perspective view of a combination beverage holder with bottle opener according to the present invention.

FIG. 2 is an environmental top view of the bottle opener according to the present invention, the support post being shown in section.

FIG. 3 is an environmental bottom view of the combination beverage holder with bottle opener according to the present invention, the support post being shown in section.

FIG. 4 is an environmental side view of the combination beverage holder with bottle opener according to the present invention.

FIG. 5 is an exploded perspective view of an alternative embodiment of a combination beverage holder with bottle opener according to the present invention, showing details of the magnet and bottle opener housing.

FIG. 6 is a perspective view of the combination beverage holder with bottle opener according to the present invention, showing an attached magnet and bottle opener housing.

FIG. 7 is a perspective view of another alternative embodiment of a combination beverage holder with bottle opener according to the present invention, showing the beverage holder extended from the base.

FIG. 8 is an exploded perspective view of the combination beverage holder with bottle opener of FIG. 7, showing the beverage holder folded into the base for storage.

FIG. 9 is a perspective view of the combination beverage holder with bottle opener of FIGS. 7 and 8.

Similar reference characters denote corresponding features consistently throughout the attached drawings.

### DETAILED DESCRIPTION OF THE PREFERRED EMBODIMENT

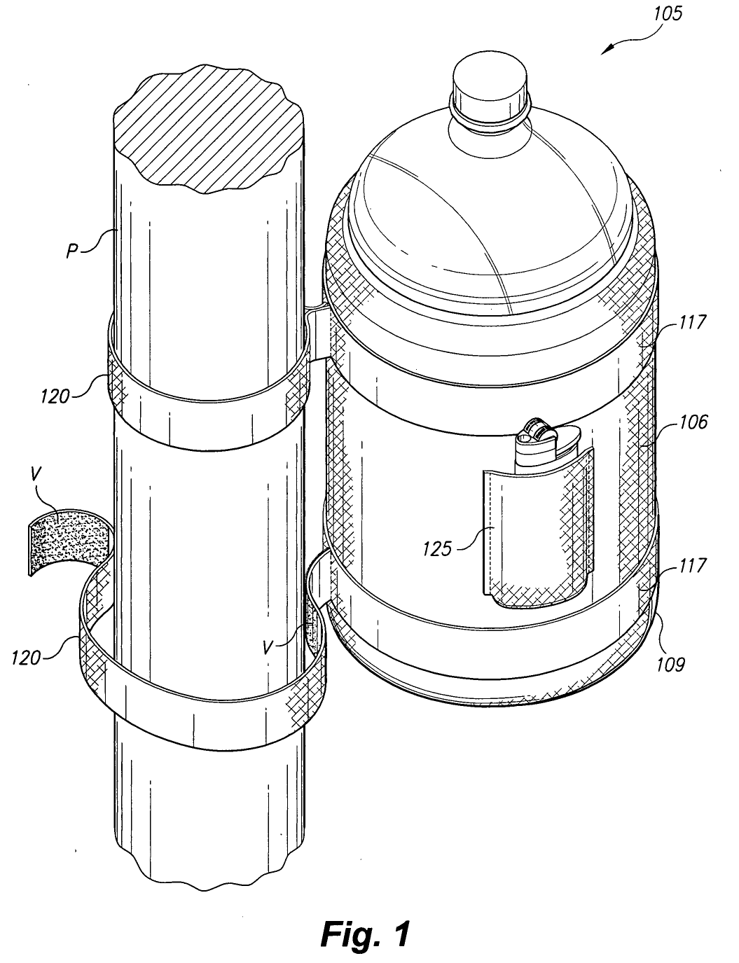

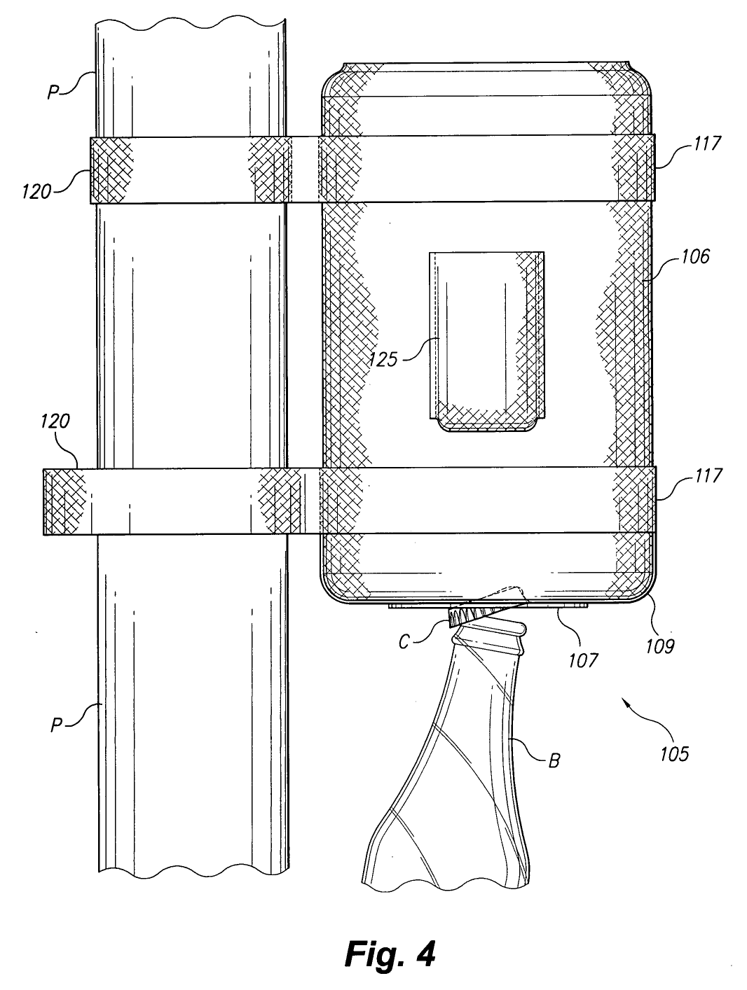

As shown in FIGS. 1 and 4, the combination beverage holder with bottle opener, designated generally as 105 in the drawings, provides an insulated beverage holder for use with cold drinking containers, and, as shown in FIG. 1, may comprise a cylindrical, substantially hollow body 106 open at its top, having a bottom wall, and a bottle opener 107 attached to the bottom wall of the substantially hollow body 106. It should be understood that body 106 may be comprised of a variety of shapes, need not be cylindrical, and may have a tapered neck as it extends to its top. Preferably the body 106 is made of a thermal insulation material capable of keeping hot beverages and cold beverages in their desired temperature ranges.

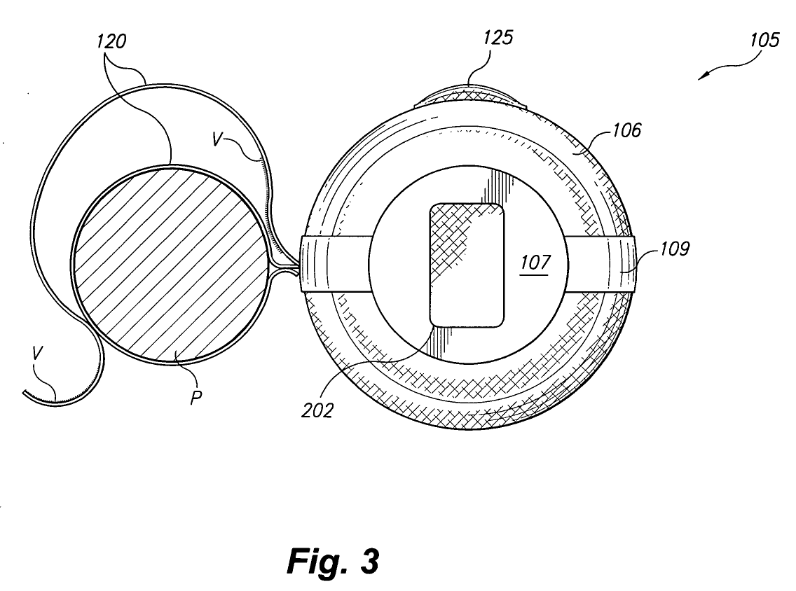

Bottle opener 107 may be of any design sufficiently dimensioned to fit on the bottom of the beverage holder body 106 as a permanent attachment thereto. As shown in FIGS. 3 and 4, the bottle opener 107 is preferably a metal disc 107 having a rectangular opening 202 in the middle to provide a pivot point about which a bottle having its cap C engaged in the opening 202 may rotate to pop off the engaged cap C from the bottle B.

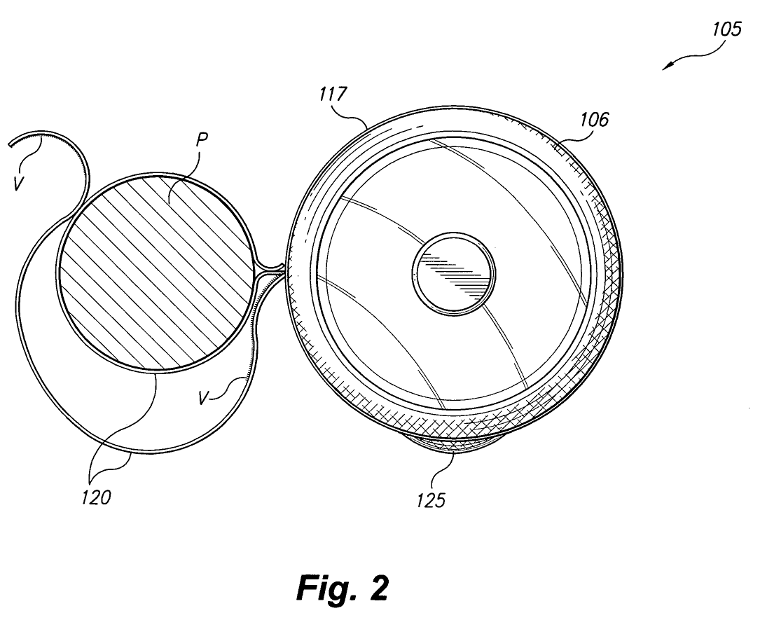

As shown in FIGS. 1, 2 and 3, a plurality of fabric straps 117 are attached around the cylindrical body 106 and have hook and loop attachment strips V at free ends of fabric strap extensions 120 for cinching the beverage holder 105 snugly to the beverage container B and for attaching the beverage holder 105 to a supporting post P or the like. The post P may be a fixed structure in a building, or may be a stanchion or other support in a boat or similar vehicle. A miscellaneous item carrying pouch 125, e.g., a cigarette lighter holder, may be disposed on the body 106 of the beverage holder 105. Reinforced plastic 109 may be disposed inside the bottom, and preferably also along the sides of the beverage holder body 106 to provide a sturdy attachment point for the bottle opener 107.

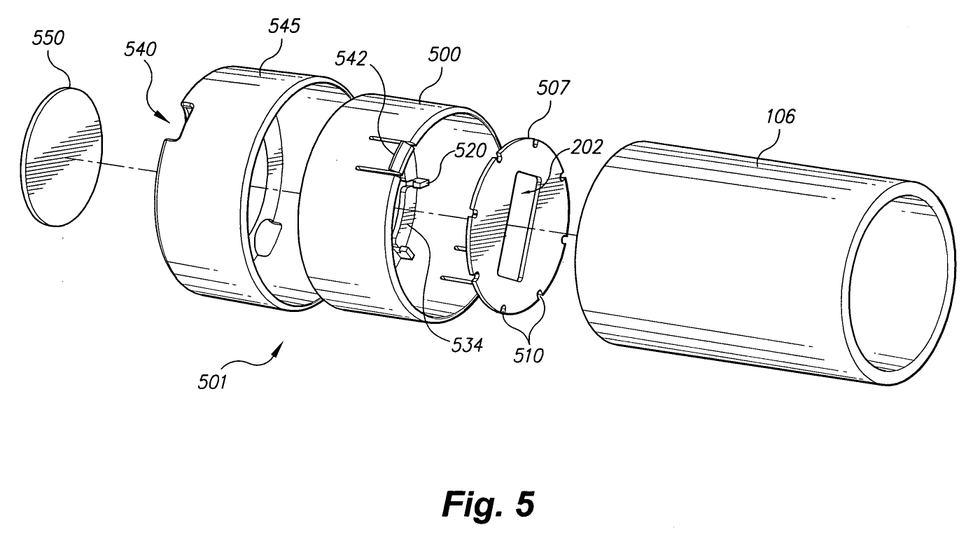

Alternatively, as shown in FIG. 5, a bottom housing 501 may be provided that encapsulates and supports a bottle opener plate 507 proximal to the bottom of the substantially hollow body drinking container holder 106. A bottle opener housing 500 is cylindrical and has an inwardly extending distal flange wall 534 that supports the circular bottle opener plate 507. A rectangular opening 202 is disposed across the opener plate 507 to provide the leverage contact surface from which a bottle cap fitted in the opening may be leveraged for pop-off action by the user.

The bottle opener plate 507 has a plurality of radial slots 510 disposed around its circumference. The distal flange wall 534 has corresponding tabs 520 in which the slots 510 can fit to secure the bottle opener plate 507 in order to prevent rotational movement of the plate 507 within the bottle opener housing 500. Preferably, the tabs 520 have an overhang directed radially inward with respect to the circular bottle opener plate 507 so that when the bottle opener plate slots 510 are aligned and mated with tabs 520, the overhang of the tabs constrains axial movement of the bottle opener plate 507.

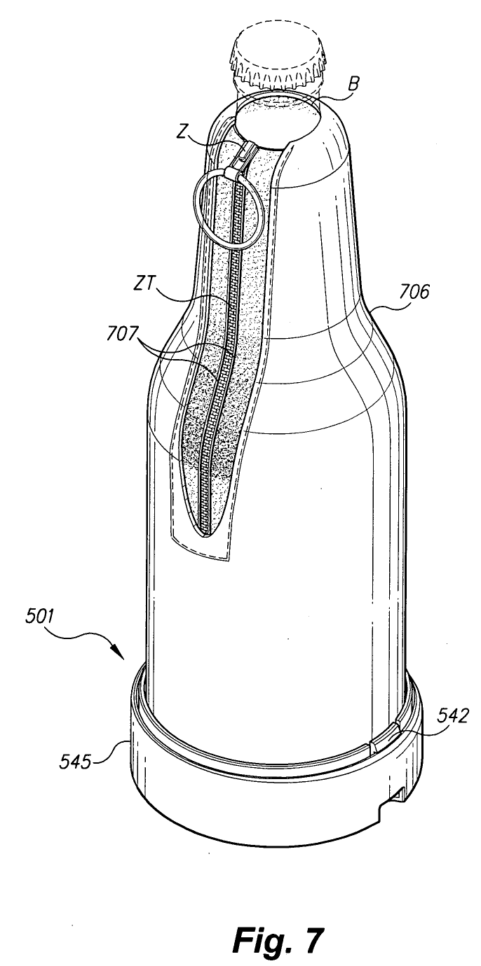

A spring lock tab 542 may extend from a distal break in the circumferential wall of the bottle opener housing 500 to the proximal (upper) portion of the housing 500. The insulated beverage holder 106, or, as shown in FIG. 7, beverage holder 706, is attached to the housing 500 by inserting the beverage holder 106 inside the circumferential wall of the housing 500 and seating the holder 106 against the flange 534. The joint may be secured by epoxy, glue, adhesive, or any other means known to those of ordinary skill in the art.

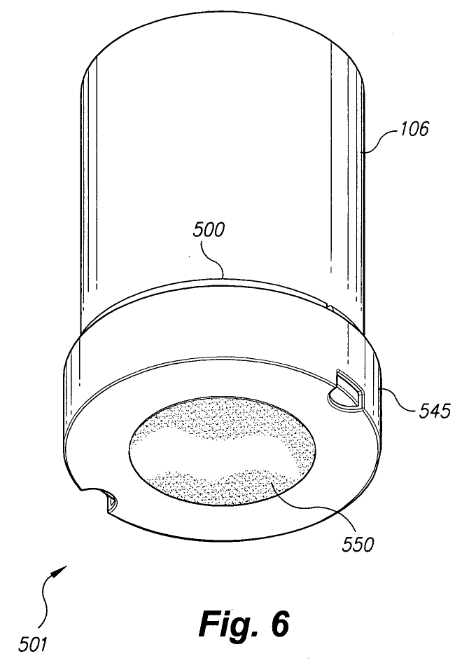

If the cylindrical bottle opener housing 500 is equipped with a spring lock tab 542, a concentric magnet housing cylinder 545 may be secured over the bottle opener housing 500 using the spring lock tab 542. As shown in FIG. 5, the magnet housing cylinder 545 has a recessed opening 540 through which the spring lock tab 542 can fit to securely hold the magnet housing cylinder 545 in concentric alignment with the bottle opener housing 500. The magnet housing cylinder 545 may be comprised of magnetic material, or it may house a magnet or plurality of magnets on its bottom surface. As shown in FIGS. 5 and 6, the bottom surface of magnet housing cylinder 545 has a recessed area in which magnetic disk 550 is attached, the attachment being secured by glue, epoxy, adhesive, or the like.

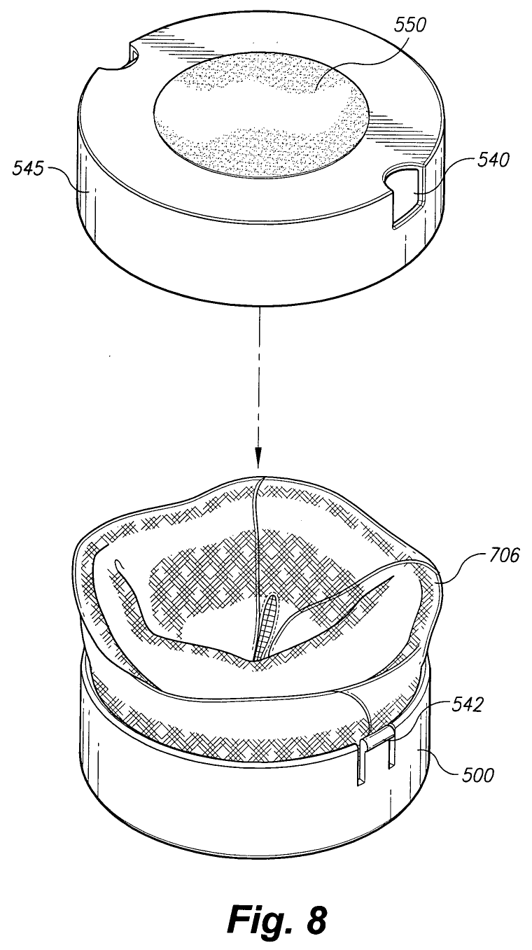

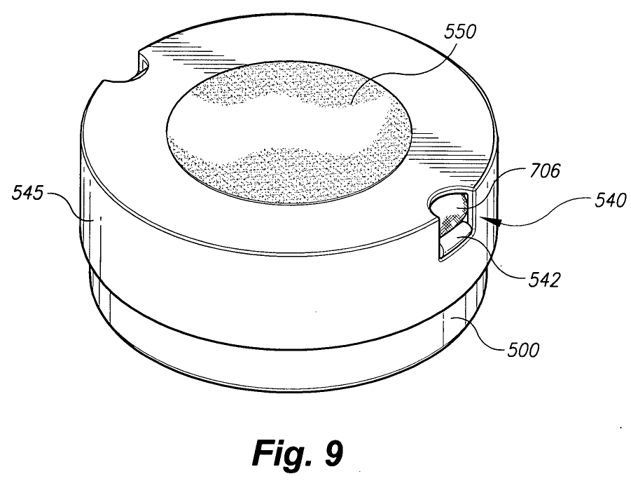

As shown in FIG. 7, a beverage holder 706 may be of a flexible, tapered bottle form-fitting shape and may also have a zipper Z attached to zipper teeth ZT, which are sewn along a longitudinally extending open seam 707 of the hollow body 706 so that the zipper Z can zip the open seam 707 shut for snugly conforming the body 706 to the bottle B. Similar to the cylindrical beverage holder 106, the bottom housing 501 houses the bottle opener plate 507 and is secured at the bottom of the tapered beverage holder 706. Preferably hollow body 706 is a collapsible fabric so that when not in use it may be collapsed down into the base 500. As shown in FIGS. 8-9, when collapsible hollow body 706 is folded into the base 500, the magnet holder 545 can be secured over the base 500 and recessed openings 540 fitted into tabs 542 for secure stowage and/or transport of the beverage holder 706.

It is to be understood that the present invention is not limited to the embodiment described above, but encompasses any and all embodiments within the scope of the following claims.

I claim:

1. A combination beverage holder with bottle opener, comprising:
a thermally insulated substantially hollow body having a closed bottom and an open top, the substantially hollow body being adapted for holding a beverage container; and
a bottle opener disposed on the bottom of the substantially hollow body.

2. The combination beverage holder with bottle opener according to claim 1, wherein the thermally insulated substantially hollow body has a tapered upper portion adapted for conforming to the shape of a bottle.

3. The combination beverage holder with bottle opener according to claim 1, wherein the hollow body has a longitudinally extending opening on its surface, fastener tracks disposed along either side of the longitudinally extending opening, and a slidable fastener attached to the fastener tracks, the fastener slidably closing the surface opening of the hollow body adapted for provide a snug fit around a beverage container disposed inside.

4. The combination beverage holder with bottle opener according to claim 1, wherein the hollow body is substantially cylindrical.

5. The combination beverage holder with bottle opener according to claim 1, wherein the bottle opener comprises a metal disc having a rectangular opening in the middle providing a pivot point for popping off a bottle cap engaging the opening.

6. The combination beverage holder with bottle opener according to claim 1, further comprising a carrying pouch disposed on the body of the beverage holder.

7. The combination beverage holder with bottle opener according to claim 1, further comprising reinforced plastic disposed inside the bottom and along the sides of the beverage holder body, providing an attachment point for the bottle opener.

8. A combination beverage holder with bottle opener, comprising:
a thermally insulated, substantially hollow collapsible body having a bottom and an open top, the substantially hollow collapsible body being adapted for holding a beverage container; and
a bottle opener disposed under the bottom of the substantially hollow body.

9. The combination beverage holder with bottle opener according to claim 8, further comprising: a bottle opener housing, the bottle opener being fixedly attached within the bottle opener housing, the bottle opener housing being attached to the bottom of the hollow body.

10. The combination beverage holder with bottle opener according to claim 9, wherein the bottle opener housing comprises an inwardly extending annular distal flange supporting the bottle opener.

11. The combination beverage holder with bottle opener according to claim 10, wherein the bottle opener housing is cylindrical and has a plurality of tabs disposed along the distal flange.

12. The combination beverage holder with bottle opener according to claim 11, wherein the bottle opener comprises a disk-shaped plate having slots disposed about the circumference of the plate, the slots engaging the flange tabs to prevent rotational movement of the plate within the bottle opener housing.

13. The combination beverage holder with bottle opener according to claim 12, wherein each of the flange tabs has an overhang directed radially inward so that when the bottle opener plate slots are aligned and mated with the flange tabs, the overhang constrains axial movement of the bottle opener plate.

14. The combination beverage holder with bottle opener according to claim 9, further comprising:
a spring lock tab extending from a distal break in an outer wall of the bottle opener housing to a proximal portion of the housing; and
a magnet housing having a bottom and a recessed opening near the bottom, the magnet housing slipping over the bottle opener housing and being selectively secured over the bottle opener housing when the spring lock tab engages the recessed opening of the magnet housing.

15. The combination beverage holder with bottle opener according to claim 14, further comprising a magnet disposed on the bottom of the magnet housing.

16. The combination beverage holder with bottle opener according to claim 8, wherein the hollow body has a longitudinally extending open seam, fastener tracks disposed along either side of the longitudinally extending open seam, and a slidable fastener attached to the fastener tracks, the fastener slidably closing the open seam of the hollow body for providing a snug fit around a beverage container disposed inside.
